(19) United States
(12) Patent Application Publication
(10) Pub. No.: US 2025/0128631 A1
(43) Pub. Date: Apr. 24, 2025

(54) VEHICLE AND POWER FEED DEVICE

(71) Applicant: TOYOTA JIDOSHA KABUSHIKI KAISHA, Toyota-shi Aichi-ken (JP)

(72) Inventor: Kaoru OHTSUKA, Mishima-shi Shizuoka-ken (JP)

(73) Assignee: TOYOTA JIDOSHA KABUSHIKI KAISHA, Toyota-shi Aichi-ken (JP)

(21) Appl. No.: 18/883,456

(22) Filed: Sep. 12, 2024

(30) Foreign Application Priority Data
Oct. 20, 2023 (JP) 2023-180868

(51) Int. Cl. B60L 53/62; B60L 50/60; B60L 53/12

(52) U.S. Cl. CPC B60L 53/62; B60L 50/60; B60L 53/12

(57) ABSTRACT

A vehicle includes: a power reception coil that contactlessly receives power from a power transmission coil on a ground; a battery that stores the power; a control device that executes charging control of the power to the battery; and a communication device that performs wireless communication with a ground-side device. Further, the control device checks a relationship between a number of devices that use each of other frequency bands different from a frequency band used for the wireless communication with the ground-side device and a radio field intensity of each of the other frequency bands, and rank channels of the other frequency bands according to a check result, and try to reconnect to the ground-side device the communication with which is interrupted in order of the ranked channels.

### CROSS-REFERENCE TO RELATED APPLICATION(S)

The present application claims priority to and incorporates by reference the entire contents of Japanese Patent Application No. 2023-180868 filed in Japan on Oct. 20, 2023.

### BACKGROUND

The present disclosure relates to a vehicle and a power feed device.

Japanese Laid-open Patent Publication No. 2019-030049 discloses that, in a contactless charging system that transmits power contactlessly from a power feed device on a ground side to a vehicle, in a case where communication between the ground-side device and the vehicle is interrupted during contactless charging, charging is continued in a communication interrupted state using information received during the communication.

### SUMMARY

There is a need for providing a vehicle and a power feed device capable of safely continuing charging even when wireless communication between a vehicle side and a ground side is interrupted during contactless power transmission by a coil on the vehicle side and a coil on the ground side.

### BRIEF DESCRIPTION OF THE DRAWINGS

FIG. 1 is a schematic diagram illustrating a contactless charging system in an embodiment;

FIG. 2 is an illustrative diagram illustrating frequency bands and channels; and

FIG. 3 is a flowchart illustrating a charging control flow.

### DETAILED DESCRIPTION

In the configuration disclosed in Japanese Laid-open Patent Publication No. 2019-030049, even if the communication is interrupted during the charging, power transmission can be continued using the information acquired during the communication, but reliability of the information decreases with the lapse of time, so that a risk of overcharging increases.

A vehicle and a power feed device in an embodiment of the present disclosure are hereinafter specifically described. Note that, the present disclosure is not limited to the embodiment described below.

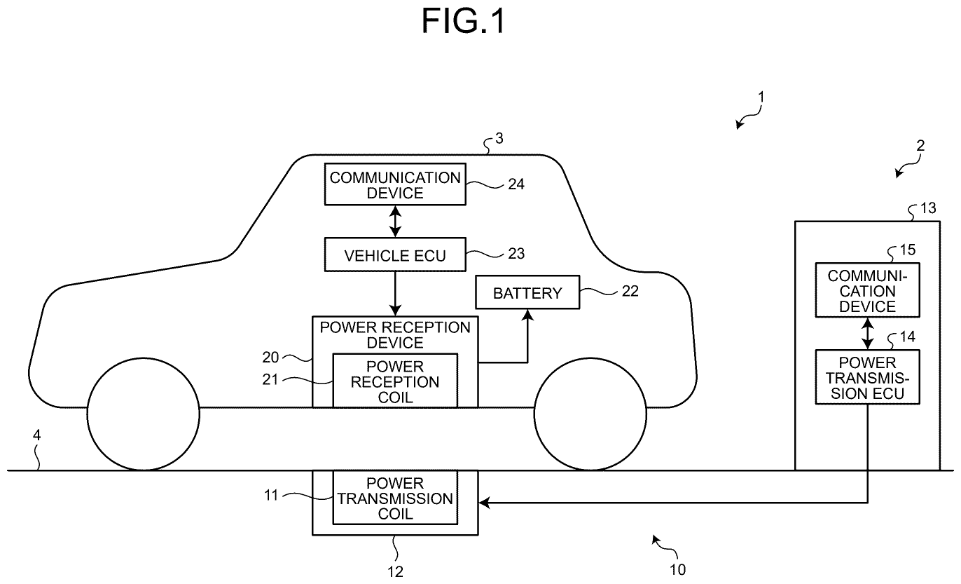

FIG. 1 is a schematic diagram illustrating a contactless charging system in the embodiment. A contactless charging system 1 is a system including a ground-side device 2 and a vehicle 3. In the contactless charging system 1, power can be transmitted contactlessly from a coil of the ground-side device 2 to a coil of the vehicle 3 in a state in which the vehicle 3 is stopped.

The ground-side device 2 is a ground facility that supplies power to the vehicle 3. For example, the ground-side device 2 is provided in a parking lot of a commercial facility, a parking lot of a house or the like. The ground-side device 2 includes a power feed device 10. The power feed device 10 is a device that transmits power to the vehicle 3 contactlessly. An AC power supply is connected to the power feed device 10. The AC power supply includes a commercial power supply, a household power supply or the like, and supplies power to the power feed device 10.

The power feed device 10 includes a power transmission coil 11, a power transmission unit 12, a wall box 13, a power transmission electronic control unit (ECU) 14, and a communication device 15.

The power transmission coil 11 is a primary coil installed on a ground 4. The power transmission unit 12 is a device including the power transmission coil 11, and is installed on the ground 4 in a parking space together with the power transmission coil 11. The wall box 13 is installed near the parking space, for example, on a wall of the parking lot or the like. The power transmission ECU 14 and the communication device 15 are installed in the wall box 13. The power transmission unit 12 and the wall box 13 are electrically connected to each other. Power from the AC power supply is supplied to the power transmission unit 12. In the power feed device 10, the power of the AC power supply is supplied to the power transmission unit 12 via a power conversion unit.

The power transmission ECU 14 is an electronic control device that controls the power feed device 10. The power transmission ECU 14 includes a processor and a memory. The processor includes a CPU or the like. The memory includes a RAM, a ROM or the like. Signals from various sensors are input to the power transmission ECU 14. The power transmission ECU 14 executes various types of control on the basis of the signals input from the various sensors. For example, the power transmission ECU 14 controls a switching element included in the power conversion unit of the power feed device 10 to adjust power for power transmission. The power transmission ECU 14 can execute power transmission control using information acquired by the communication device 15. This power transmission control is wireless power transmission control to the vehicle 3.

The communication device 15 performs wireless communication with the vehicle 3 parked in the parking space. The communication device 15 transmits information from the power transmission ECU 14 to the vehicle 3 and receives information transmitted from the vehicle 3. The communication device 15 can perform wireless communication by, for example, Wi-Fi (registered trademark) or a wireless LAN.

The vehicle 3 is an electric vehicle capable of charging power transmitted from the ground-side device 2 contactlessly. For example, the vehicle 3 is formed of a battery electric vehicle (BEV), a hybrid electric vehicle (HEV), a plug-in hybrid electric vehicle (PHEV) or the like. The vehicle 3 can stop in the parking space in which the power transmission coil 11 is installed.

The vehicle 3 includes a power reception device 20, a power reception coil 21, a battery 22, a vehicle ECU 23, and a communication device 24.

The power reception device 20 includes the power reception coil 21 installed in a lower part of a vehicle body of the vehicle 3. The power reception coil 21 receives the power transmitted from the power transmission coil 11 contactlessly. The power reception device 20 supplies the power received from the power feed device 10 to the battery 22. The power feed device 10 and the battery 22 are electrically connected to each other.

The battery 22 is an in-vehicle battery that can be externally charged. The battery 22 stores the power received by the power reception device 20. The battery 22 includes a secondary battery that stores the power supplied from the power reception device 20.

The vehicle ECU 23 is an electronic control device that controls the vehicle 3. The vehicle ECU 23 has a hardware configuration similar to that of the power transmission ECU 14. The vehicle ECU 23 executes various types of vehicle control on the basis of the signals input from the various sensors mounted on the vehicle 3 and information acquired by communication using the communication device 24. The vehicle control includes charging control to store the power transmitted from the power transmission unit 12 contactlessly in the battery 22. The charging control is control in which power is transmitted contactlessly from the power transmission coil 11 to the power reception coil 21, and the power received by the power reception coil 21 is stored in the battery 22.

The communication device 24 performs wireless communication with an external device such as the ground-side device 2. The communication device 24 performs the wireless communication with the communication device 15 of the power feed device 10 when the vehicle 3 performs contactless charging. The communication device 24 transmits the information from the vehicle 3 to the power feed device 10, and receives the information transmitted from the power feed device 10 to the vehicle 3.

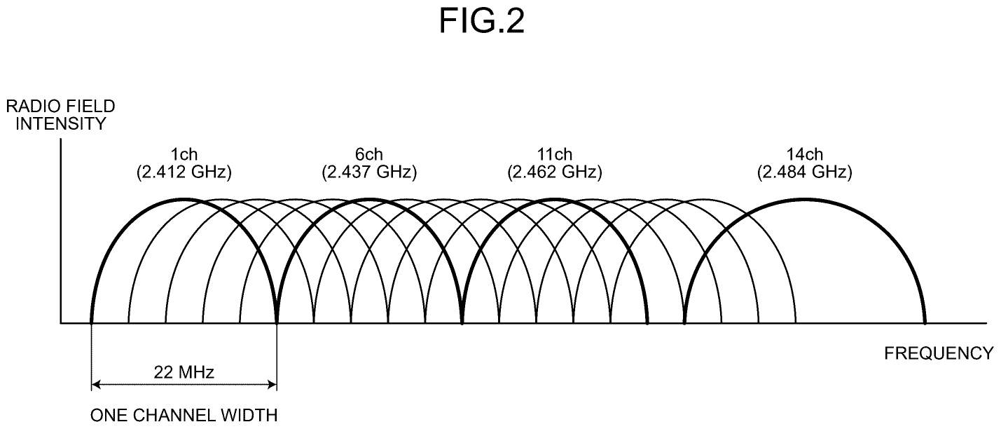

In a case where the wireless communication using Wi-Fi (registered trademark) is performed between the ground-side device 2 and the vehicle 3, the communication device 15 and the communication device 24 perform wireless communication using a channel for each predetermined frequency band as illustrated in FIG. 2. In this case, there are channels of frequency bands that do not interfere with one another at intervals of five channels, such as 1ch, 6ch, and 11ch. Therefore, when the contactless charging is performed, the wireless communication can be established between the ground-side device 2 and the vehicle 3 using any one of channels of 1ch, 6ch, and 11ch.

In the contactless charging system 1, the contactless charging is performed from the power feed device 10 to the vehicle 3 in a state in which the wireless communication is established between the vehicle 3 and the power feed device 10. Power is transmitted contactlessly from the power transmission coil 11 on the ground side to the power reception coil 21 on the vehicle side in a state in which the vehicle 3 and the power feed device 10 are paired by the wireless communication. In the vehicle 3, control is performed to supply the power received by the power reception coil 21 to the battery 22.

In the contactless charging system 1 configured in this manner, the wireless communication between the vehicle 3 side and the ground side might be interrupted during the contactless charging from the ground-side device 2 to the vehicle 3. When the communication remains interrupted during the charging, the charging can be continued, whereas there is a risk of overcharging the battery 22. Therefore, the contactless charging system 1 is configured to be able to reconnect the communication at an early stage when the communication is interrupted during the charging and to continue charging more safely.

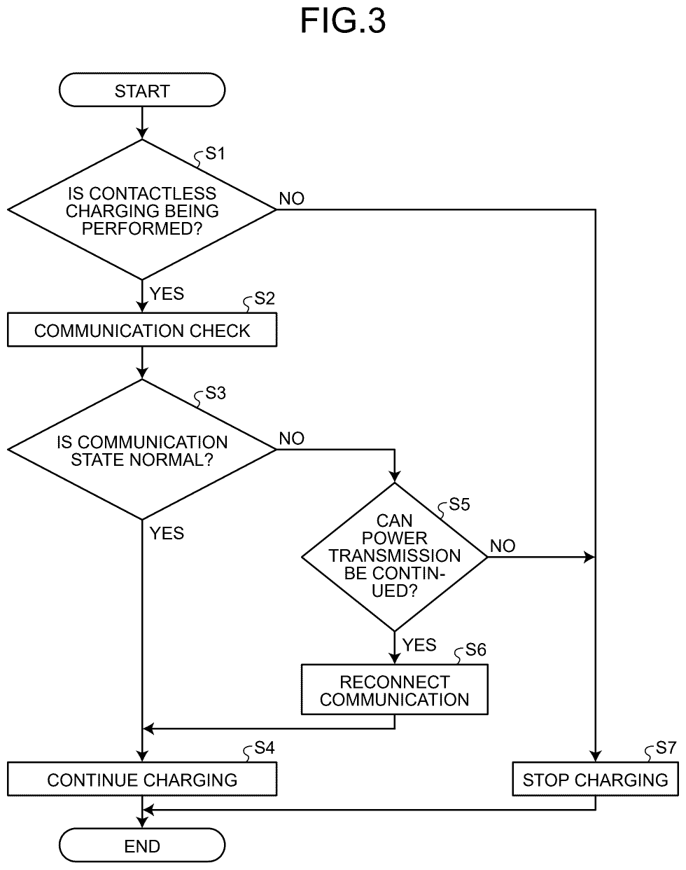

FIG. 3 is a flowchart illustrating the charging control. The control illustrated in FIG. 3 is executed by the power transmission ECU 14.

The power transmission ECU 14 determines whether the contactless charging from the ground-side device 2 to the vehicle 3 is being performed (Step S1). At Step S1, it is determined whether the power transmission control by the power transmission ECU 14 is being executed.

In a case where it is determined that the contactless charging from the ground-side device 2 to the vehicle 3 is being performed (Step S1: Yes), the power transmission ECU 14 performs communication check (Step S2). The communication device 15 of the ground-side device 2 includes a system that measures an intensity of wireless connection and a congestion degree. The congestion degree is used to grasp the number of use for each channel of the wireless communication in a surrounding environment. In Wi-Fi (registered trademark), channel setting as illustrated in FIG. 2 is possible, and the communication device 15 can grasp the used channel and the number of devices that use this channel in a wireless communication environment. At Step S2, the number of devices (the number of used devices) using each of the frequency bands at intervals of five channels that do not interfere with one another, such as 1ch, 6ch, and 11ch, is checked around the ground-side device 2. In addition, a radio field intensity of each of the frequency bands at intervals of five channels that do not interfere with one another, such as 1ch, 6ch, and 11ch, is checked around the ground-side device 2. Then, a relationship between the number of used devices and the radio field intensity is checked for each channel (for each predetermined frequency band). This relationship is expressed by a ratio of the number of used devices to the radio field intensity. At Step S2, for each of 1ch, 6ch, and 11ch, the power transmission ECU 14 checks the number of used devices and the radio field intensity in the channel, and calculates a value obtained by dividing the number of used devices by the radio field intensity. The calculated value is equal to the ratio of the number of used devices to the radio field intensity. A smaller value (ratio) indicates more desirable communication. A channel having a minimum ratio of the number of used devices to the radio field intensity is a channel with the most desirable communication. Moreover, the power transmission ECU 14 ranks channels with desirable communication. The power transmission ECU 14 ranks the channels in such a manner that a smaller calculated ratio ranks higher.

The power transmission ECU 14 determines whether a communication state between the ground-side device 2 and the vehicle 3 is normal (Step S3). At Step S3, it is determined whether the wireless communication between the ground-side device 2 and the vehicle 3 is interrupted.

In a case where it is determined that the communication state between the ground-side device 2 and the vehicle 3 is normal (Step S3: Yes), the power transmission ECU 14 continues the contactless charging from the ground-side device 2 to the vehicle 3 (Step S4). When a process at Step S4 is performed, this control routine ends.

In a case where it is determined that the communication state between the ground-side device 2 and the vehicle 3 is not normal (Step S3: No), the power transmission ECU 14 determines whether the power transmission from the ground-side device 2 to the vehicle 3 can be continued (Step S5). At Step S5, it is determined whether the battery 22 is not overcharged. Using the information acquired before the wireless communication between the ground-side device 2 and the vehicle 3 is interrupted, for example, using the SOC of the battery 22, in a case where the SOC is lower than an upper limit value of the SOC and there is a margin, it can be determined that the power transmission can be continued.

In a case where it is determined that the power transmission from the ground-side device 2 to the vehicle 3 can be continued (Step S5: Yes), the power transmission ECU 14 reconnects the communication between the ground-side device 2 and the vehicle 3 (Step S6). At Step S6, it is tried to reconnect the communication between the ground-side device 2 and the vehicle 3 the communication between which is interrupted in the order of the channels ranked at Step S2. When recovering from the interruption of the communication during the charging, the power transmission ECU 14 tries to reconnect the ground-side device 2 and the vehicle 3 the communication between which is interrupted in order from the higher ranked channel. For example, in a case where 1ch is used for the wireless communication between the ground-side device 2 and the vehicle 3, other frequency bands different from this are 6ch and 11ch without interference. The power transmission ECU 14 tries to reconnect at 6ch in a case where 6ch is higher than 11ch in the ranking at Step S2, and tries to reconnect at 11ch in a case where 11ch is higher than 6ch in the ranking at Step S2. The reconnection in a more desirable communication state is tried. A process at Step S2 is performed before a communication abnormality occurs between the ground-side device 2 and the vehicle 3. Therefore, as compared with a case where the relationship between the number of used devices and the radio field intensity is checked for each channel after the occurrence of the communication abnormality and the channels are ranked on the basis of the relationship, the calculation is performed before the occurrence of the abnormality at Step S2, so that a time until the reconnection at Step S6 is completed can be shortened.

In a case where it is determined that the power transmission from the ground-side device 2 to the vehicle 3 cannot be continued (Step S5: No), the power transmission ECU 14 stops the charging by the wireless power transmission from the ground-side device 2 to the vehicle 3 (Step S7). At Step S7, the power transmission from the power transmission coil 11 is stopped. When a process at Step S7 is performed, this control routine ends.

In a case where it is determined that the contactless charging from the ground-side device 2 to the vehicle 3 is not being performed (Step S1: No), this control routine proceeds to Step S7.

As described above, according to the embodiment, since the communication check is completed before the occurrence of the communication abnormality, it is possible to shorten the time until the reconnection is completed after the communication interruption. Accordingly, it is possible to shorten a communication interruption period with an overcharging risk. As a result, the overcharging risk can be reduced.

Note that, the power feed device 10 is not necessarily include the wall box 13. In the power feed device 10, the power transmission ECU 14 and the communication device 15 can be installed on the ground 4 together with the power transmission unit 12.

The ground-side device 2 may be installed in the parking lot including a plurality of parking spaces. In this case, the power feed device 10 is installed for each parking space.

Wi-Fi (registered trademark) channels may be a combination of every five channels that do not interfere with one another, and are not limited to a combination of 1ch, 6ch, and 11ch. For example, a combination of 2ch, 7ch, and 12ch or a combination of 3ch, 8ch, and 13ch may be used.

The control illustrated in FIG. 3 may be performed not only by the power transmission ECU 14 but also by the vehicle ECU 23. For example, the vehicle ECU 23 can perform processes at Steps S1 to S7 illustrated in FIG. 3. In this case, the communication device 24 of the vehicle 3 includes a system that measures the intensity of the wireless connection and the congestion degree. Moreover, at Step S5, the vehicle ECU 23 determines whether it is possible to continue power reception from the ground-side device 2.

The present disclosure can safely continue charging even when wireless communication between a vehicle side and a ground side is interrupted during contactless power transmission by a coil on the vehicle side and a coil on the ground side.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle comprising:
a power reception coil that contactlessly receives power transmitted from a power transmission coil on a ground side;
a battery that stores the power received by the power reception coil;
a control device that executes charging control of supplying the power, which is contactlessly transmitted from the power transmission coil to the power reception coil, to the battery; and
a communication device that performs wireless communication with a ground-side device including the power transmission coil, wherein
the control device is configured to
check a relationship between a number of devices that use each of other frequency bands different from a frequency band used for the wireless communication with the ground-side device and a radio field intensity of each of the other frequency bands, and rank channels of the other frequency bands according to a check result before a communication abnormality occurs between the ground-side device and the communication device, and
try, in a case where the communication with the ground-side device is interrupted during charging of the power supplied from the power transmission coil, to reconnect to the ground-side device the communication with which is interrupted in order of the ranked channels.

2. The vehicle according to claim 1, wherein
the relationship between the number of devices and the radio field intensity is expressed by a ratio of the number of devices to the radio field intensity, and
the control device is configured to
calculate the ratio of the number of devices to the radio field intensity for each of the other frequency bands, and ranks the channels corresponding to the other frequency bands in such a manner that a smaller calculated ratio ranks higher, and
try, upon recovering from the interruption of the communication, to reconnect to the ground-side device the communication with which is interrupted in order from a higher ranked channel.

3. The vehicle according to claim 2, wherein
the control device is configured to check the relationship between the number of devices and the radio field intensity and ranks the channels after the communication with the ground-side device is established and before receiving the power from the power transmission coil.

4. A power feed device comprising:
a power transmission coil installed on a ground;
a control device that controls power transmission to contactlessly transmit power from the power transmission coil to a power reception coil mounted on a vehicle; and
a communication device that performs wireless communication with the vehicle, wherein
the control device is configured to
check a relationship between the number of devices that use each of other frequency bands different from a frequency band used for the wireless communication with the vehicle and a radio field intensity of each of the other frequency bands, and rank channels of the other frequency bands according to a check result before an occurrence of a communication abnormality between the vehicle and the communication device, and
try, in a case where the communication with the vehicle is interrupted during power transmission from the power transmission coil to the power reception coil, to reconnect to the vehicle the communication with which is interrupted in order of the ranked channels.

5. The power feed device according to claim 4, wherein
the relationship between a number of devices and the radio field intensity is expressed by a ratio of the number of devices to the radio field intensity, and
the control device is configured to
calculate the ratio of the number of devices to the radio field intensity for each of the other frequency bands, and rank the channels corresponding to the other frequency bands in such a manner that a smaller calculated ratio ranks higher, and
try, when recovering from the interruption of the communication, to reconnect to the vehicle the communication with which is interrupted in order from a higher ranked channel.

6. The power feed device according to claim 5, wherein
the control device is configured to check the relationship between the number of devices and the radio field intensity and rank the channels before transmitting the power from the power transmission coil after the communication with the vehicle is established.
